(19) United States
(12) Patent Application Publication
(10) Pub. No.: US 2004/0064413 A1
(43) Pub. Date: Apr. 1, 2004

(54) Money receiving device

(76) Inventors: Christoph Mätzig, Ampfing (DE); Dirk Schelling, Starnberg (DE)

Correspondence Address: BACON & THOMAS, PLLC, 625 SLATERS LANE, FOURTH FLOOR, ALEXANDRIA, VA, 22314

(21) Appl. No.: 10/450,526

(22) PCT Filed: Dec. 19, 2001
(86) PCT No.: PCT/EP01/15017

(30) Foreign Application Priority Data
Dec. 21, 2000 (DE) 100 64 007.9

(51) Int. Cl. G06F 17/60

(52) U.S. Cl. 705/42

(57) ABSTRACT

The invention relates to a cash handling apparatus and a method in which, during one transaction, banknotes are both paid in and paid out again.

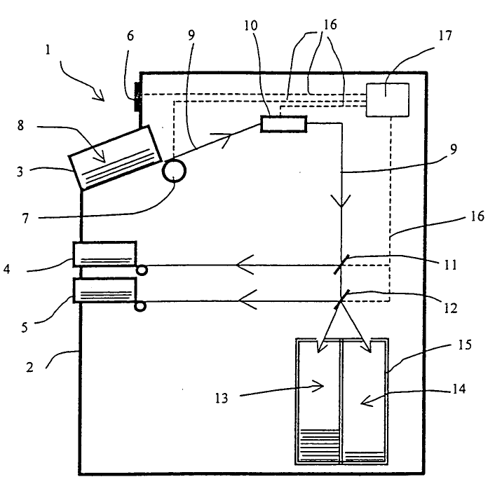

In order to permit rapid performance of the transaction, the predefinition of data about the banknotes to be output again is made before the banknotes are drawn separately into the cash handling apparatus.

The invention relates to a cash handling apparatus and a method in which, during one transaction, banknotes are both paid in and output again.

Such systems, in which paying in and paying out cash are combined in one transaction are described, inter alia, in WO 94/25940, DE 34 31 205 A1 and EP 0 735 513 A1.

These systems are used, for example, as cash registers in retail trade. In this case, a operator normally enters data about the amount of money to be retained, such as the price of the goods purchased, into the system and then places in the input compartment of the system banknotes whose total value corresponds at least to the price of the goods purchased, that is to say the amount of money to be retained in the machine.

The banknotes are then drawn in separately, their authenticity is checked and their denomination determined. They are then deposited stacked in an intermediate register or in a final cassette. After all the banknotes paid in have been drawn in, checked and stacked, their total value is calculated on the basis of the determination of the denomination.

After this, the difference between the total value of the banknotes paid in and the amount of money actually to be retained is determined. This difference is given back to the operator again in the form of banknotes and/or coins from at least one separate banknote or coin storage container.

An alternative system with paying in and paying out of money during one transaction is described in WO 97/43734.

In this case, banknotes are likewise drawn separately into the machine, their denomination is determined and the banknotes are then either stacked in a final register or an intermediate store. After the total value of the banknotes paid in has been calculated in accordance with the results of the determination of the denomination, the operator can specify the quantity of banknotes which he would like to be paid back.

From a storage device, which can comprise a plurality of storage containers, in which the banknotes are stored separately in accordance with denomination, the desired number of banknotes is then output again. If the banknotes previously paid in during the transaction have not been stacked directly in an end cassette, these are transported into the end cassette and stored before or after the paying out of the amount of money to be given back.

All these known systems have the disadvantage that the performance of a transaction lasts a long time, since first of all the banknotes have to be drawn into the machine completely, and checked, stacked, their total value determined and then, in accordance with the predefinition entered by the operator, a specific amount of money is output again. In order to perform such transactions, an apparatus of mechanically complex construction is additionally necessary, which makes the system susceptible to faults and expensive.

On this basis, it is the object of the present invention to provide a method and a cash handling apparatus for performing transactions in which banknotes are both paid in and output again, which permits rapid performance of the transactions and, at the same time, makes it possible for the apparatus for performing the transactions to be constructed simply.

This object is achieved by the method according to claim 1 and the cash handling apparatus according to claim 10. Advantageous embodiments form the subject matter of subclaims.

In this case, the present invention resulted on the basis of the finding that a quicker performance of transactions with coupled banknote input and output can be implemented, with a simultaneously simplified construction of the cash handling apparatus, if, even before the banknotes inserted are drawn in, it is specified which banknotes are to be output again, for example how many banknotes of the respective denominations.

The predefinition of data can in this case be carried out, for example, manually by the operator, who enters the data via an input unit such as a keyboard or a touch screen. Alternatively, for example, it is also possible for these data, for example, to be previously stored in a control computer of the apparatus or even supplied automatically by (remote) data transmission.

Since, for example, the operator specifies data about the banknotes to be paid out again, the apparatus according to the invention can be used as a cash handling apparatus for transferring or cashing up cash registers in department stores, in shopping centres, in the back-office branch of banks or the like, with which the output of change in predetermined quantities is possible.

If the entire stock of banknotes of a cash register is paid into the cash handling apparatus, then it is possible for the change needed for the next day for the same cash register to be output automatically again in a suitable mixture, that is to say in the desired number of banknotes per denomination. Therefore, the operator or the cash register personnel who present the operator with the cash register contents for cashing up no longer themselves take the change needed for the next day from the cash register stock by hand during cashing up before the rest is put into the cash handling apparatus.

Since, in addition, the entry of the data about the banknotes to be paid out again is carried out even before the banknotes are drawn in, some of the banknotes drawn in, following the determination of their denomination, can be output immediately again into the output compartment in the previously entered quantity as the desired change, while the remaining banknotes, not be output again, can be transported into the storage device and, for example, stored in an individual end cassette.

These advantages cannot be implemented with any of the known systems. Neither with the systems according to WO 94/25940, DE 3431 205 A1 and EP 0 735 513 A1, in which, before the banknotes are drawn in, it is the amount of money to be retained rather than that to be paid out again which has to be specified, nor with the system according to WO 97/43734, in which the amount to be output again can be specified only after the banknotes have been drawn in.

These systems necessarily require all of the money inserted to be drawn in first and counted and its total value determined before change can be output. This means that, whereas in the solution according to the invention, it is possible to start paying out change immediately after the start of the operation of drawing in the banknotes, this is not possible in the known systems; instead, paying out can be started only after all the banknotes have been drawn in completely.

The system according to the invention not only permits acceleration of the performance of the combined cash paying-in and paying-out transactions but, moreover, that the apparatus used is produced in a manner mechanically more simple, less susceptible to faults and therefore more cost-effective.

According to a particularly advantageous embodiment, to this end the banknotes put in during the current transaction are transported separately from the input device to the output device without intermediate stacking, in order to output banknotes again in accordance with the predefined data.

Since, consequently, it is possible to dispense with the means, absolutely necessary in the known systems, for the (intermediate) stacking of all the banknotes paid in in order to determine their total value, a mechanically simply constructed apparatus can be implemented, in which the banknotes, immediately after the detection of their denomination, are transported either directly into the output compartment or alternatively into the storage device.

Particularly preferably, at least some or in particular all the banknotes output again will be notes which have previously been input during the current transaction and, following the determination of denomination, are deflected into the output compartment in accordance with the predefinitions.

If, in this case, banknotes just paid in only during the current transaction are output again, it is possible to dispense with banknote storage devices, from which the change to be output again originates. Neither a film storage device nor a plurality of banknote storage containers is needed, in which the banknotes have to be stored in individual denominations if change is also to be output in different denominations. In this case, too, the system according to the invention, as compared with the known apparatuses, can be constructed particularly simply in mechanical terms and therefore produced inexpensively.

In the simplest case, therefore, an apparatus according to the invention can have only one individual end cassette, in which, following the detection of denomination, the banknotes which are not to be output again as change are deposited and, nevertheless, can also output change in different denominations.

In the following text, first of all in each case a preferred embodiments [sic] of the apparatus according to the invention or the method according to the invention will be explained by using the single appended FIGURE. Subsequently, some further exemplary embodiments will be described. In this case, the single

FIGURE shows a schematic cross-sectional view through a cash handling apparatus according to a first exemplary embodiment.

The cash handling apparatus according to the first exemplary embodiment is designated overall by the reference number 1. On the front side of the apparatus 1, in the housing 2 of the apparatus 1 and freely externally accessible to an operator there are integrated an input compartment 3, two output compartments 4, 5 and an operating unit 6 which, for example, has a touch screen both for display and for the entry of data.

Furthermore, in the interior of the housing 2 there are a separator 7, a transport path 9, a checking device 10, an end cassette 15 and a control device 17.

By means of the separator 7, the banknotes 8 in the input compartment 3 are separated and supplied via the transport path 9 to the checking device 10. The checking device 10 is designed in particular for detecting the authenticity and for determining the denomination and suitability for circulation of banknotes, for which purpose, for example, optical, magnetic or other properties of the banknotes are checked.

The transport path 9 is, furthermore, constructed in such a way that the separated banknotes 8, after passing through the checking device 10, are transported to one of the storage units 4, 5, 15. To this end, after the checking device 10 in the transport path 9 there are two diverters 11, 12. By means of the first diverter 11, the banknotes which have passed through the checking device 10 are transported either to the first output compartment 4 or to the second diverter 12. The second diverter 12 is, in comparison, designed in such a way as to transport the banknotes which have passed the first diverter 11 either to the second output compartment 5 in the direction of the arrow D or to one of two storage compartments 13, 14 in the banknote end cassette 15.

The operating unit 6, the separator 7, the checking device 10, and the diverters 11, 12 are all connected via signal lines 16 to the control unit 17. The control unit 17 is designed, inter alia, to instruct the operator, with the aid of the display of the operating unit 6, to carry out the entry of the data about the banknotes 8 to be output again before the banknotes 8 are drawn separately into the cash handling apparatus 1, if an output of change is desired.

The control unit 17 is also used to switch the diverters 11, 12 in such a way that, after being transported through the checking device 10, the separated banknotes 8 are transported, on the basis of the registered denomination and the predefinitions entered with the aid of the operating unit 6, into one of the four storage compartments, that is to say either into one of the two externally accessible output compartments 4, 5 or into one of the two storage compartments 13, 14 in the cassette 15.

According to a first exemplary embodiment, this apparatus 1 is used as follows in order to perform the method according to the invention.

The cash handling apparatus 1 is in this case to be used, for example, for cashing up the daily receipts of cash registers in a shopping centre. To this end, the operator who performs the cash register cashing up is first identified, for example by means of a chip or magnetic card and/or a PIN code input. In particular if the cash handling apparatus is used to cash up a plurality of cash registers, the operator will also enter identification data relating to the cash register subsequently to be cashed up. Then, by means of the operating unit 6, the operator will activate the change function in order to output banknotes again, by selecting, for example, the option “change” in a display menu.

Then, the operator will enter the data which are needed to output the banknotes again. This may be, for example, statements about the number of banknotes per denomination which are to be output again as change for the cash register being cashed up at the time. Furthermore, it is conceivable for the data to comprise statements about the total value of the banknotes to be paid out again or statements as to which denominations are to be output again. In the last-named case, the operator could specify, for example, that he would like to receive all the 10 DM notes paid in paid out again.

If this has not previously been done, the operator will then insert the entire banknote stock of the cash register to be cashed up at the time into the compartment 3 of the cash handling apparatus 1, either in an individual stack or, in the event of a limited holding capacity of the input compartment 8, one after another in a number of stacks. If the banknotes are not drawn in automatically when the banknotes 8 are present in the compartment 3, the start of the separation is activated by the operator by means of the operating unit 6.

The control computer 17 then drives the separator 7 via signal lines 16 in such a way that the banknotes 8 of the banknote stack inserted into the compartment 3 are successively drawn separately into the cash handling apparatus 1. The banknotes 8 inserted are then conveyed individually with the aid of the transport system 9 to the checking device 10 and pass through the latter. In the process, the checking device 10 checks the authenticity of the banknotes 8 transported through and determines their denomination. The results of the check are transmitted to the control computer 17 via the signal lines 16.

Depending on the checking results and the definitions previously entered by the operator about the change to be output again, the control computer 17 will switch the diverters 11 and 12 in such a way that the individual banknotes, after passing through the checking device 10, are in each case transported to one of the four storage regions 4, 5, 13, 14.

The control can be carried out, for example, in such a way that all the banknotes not recognised by the checking device 10 or not suitable for circulation are transported via the diverter 11 to the output compartment 4, that in this case serves as a reject compartment. In addition, for example, all banknotes recognised as false or suspected of being forgeries can be transported into the separate storage compartment 14 present in the end cassette 15.

The remaining banknotes, that is to say those recognised as authentic, are finally transported either into the externally accessible compartment 5 for the output of change or transported into the storage region 13 in the cassette 15. The decision as to into which of these two compartments 5, 13 the authentic banknotes are transported depends on the determination of the banknotes and the predefinition entered by the operator about the banknotes to be output again.

As an example, let it be assumed that the operator, before the start of the operation of drawing in the banknotes, has entered the fact via the operating unit 6 then he wishes to receive 20 10 DM notes and 15 20 DM notes output again as change.

In this case, the control computer 17 drives the diverter 11, 12 in such a way that the first 20 10 DM notes and the first 15 20 DM notes which are drawn in during the current transaction and are checked as authentic with the aid of the checking device 10 are transported to the output compartment 5 and stored there as the desired change. All other authentic banknotes, that is to say in the case described as an example, all the banknotes of another denomination than 10 DM or 20 DM and, furthermore, all 10 DM notes beginning at the 21st banknote and all 20 DM notes beginning at the 16th banknote are transported into the compartment 13 in the end cassette 15 and stored.

If, in during the first passage, non-identifiable banknotes have been output into the reject compartment 4, these can be inserted at least once more into the input compartment 8, in order to be separated once more and subsequently checked in the checking unit 10.

After the entire banknote stock of the cash register to be cashed up during the current transaction has been drawn in by the operator and stored in the four storage regions 4, 5, 13, 14 in accordance with the criteria mentioned previously, the operator ends the banknote drawing-in function for the transaction current at that time through an entry by means of the operating unit 6.

Following the completion of the drawing-in of the banknotes for the cash register to be cashed up at that time, the operator can then remove the banknotes from the externally accessible output compartments 4 and 5. In particular, he will then remove the 20 10 DM notes and 15 20 DM notes which, in accordance with his or her predefinitions, have been output into the output compartment 5 again as change.

The total value of the banknotes retained in the storage region 13 of the cassette 15 and also of the banknotes output again is calculated by the control computer 17 in accordance with the detection of denomination determined by the checking device 10, for subsequent traceability with statements about the identity of the cash register cashed up at that time and the cashing-up period and possible additional informative data. For information, these data are also displayed to the operator on the monitor of the operating unit 6 and/or can be printed out via a printer as a receipt.

If the cash handling apparatus 1 is not permanently installed but is mobile, the operator will then go, with the cash handling apparatus 1, to the next cash register to be cashed up and will perform the cashing-up operation described above in the same manner with the banknote stock of this further cash register.

In addition to the exemplary embodiments described above, of course further numerous variants are possible.

For instance, it is not absolutely necessary for the banknotes paid in to be checked for their authenticity. In this case, for example, all the banknotes not accepted by the checking device 10 could be output into the reject compartment 4 and, in addition, a separate storage compartment 14 for the false banknotes or banknotes suspected of being forgeries could be dispensed with.

Furthermore, although in the cases described above the banknotes to be output again as change are output in a single output compartment 5, it is alternatively also conceivable for there to be a plurality of such output compartments 5. This is advantageous, in particular, if the banknotes have not already been put into the input compartment 3 separated by denomination. In the event of banknotes being output into a single output compartment 5, the banknotes in this case would very probably be output in an order likewise not separated by denomination. However, if there is a plurality of output compartments, the output into the individual compartments can be controlled in such a way that in each case only banknotes of a single denomination are output into one of the compartments.

Furthermore, whereas in the apparatus according to the single FIGURE the banknotes to be retained, that is to say those which are authentic and not be output again, are transported into the end cassette 15 for storage directly after the checking by the checking device 10, there can also be an intermediate cash register for the banknotes to be retained.

This could be, for example, a third output compartment likewise integrated on the front side of the apparatus 1, in which the banknotes to be retained are stacked following checking. In this case, the third output compartment can be configured such that it can be closed again by a transparent cover, for example controlled by the control computer 17, in order to prevent undesired access to the compartment.

If all the banknotes in the current transaction have been put in and stored in one of the storage compartments, in this case the total amount, determined by the control computer 17, of the banknotes to be retained, that is to say stacked at that time in the third compartment serving as an intermediate cash register, can be displayed to the operator. In this case, the compartment will be closed by the cover in order that no banknotes can be taken out.

If the operator agrees with this statement and considers the data displayed to be correct, then he confirms this via the operating unit 6, and the banknotes in the third output compartment are transferred into the final cash register, that is to say into the cassette 15.

Otherwise, the cover is opened and the banknotes in the third compartment can be removed again.

In this case, the control computer 17 can drive the diverters 11, 12, for example in such a way that the first banknotes drawn in during the current transaction are output directly into the output compartment 5 for change again until the predefined total value has been reached.

However, the apparatus can alternatively also be configured in such a way that there is only a single output compartment and not a plurality of output compartments 4, 5. In this case, for example, the banknotes paid in which are not accepted by the checking device 10 can be diverted immediately into this single output compartment. The proportion of the banknotes put in which is to be output again in accordance with the predefinitions is in this case conveyed into an intermediate store, and the remaining banknotes, that is to say those to be paid in finally, are stored in the end cassette 15. After the other accepted banknotes have been removed from the output compartment by the operator and possibly put into the input compartment 8 again for repeating checking, the banknotes already previously sorted, intermediately stored as change and to be output again are output into this single output compartment.

As a further alternative, it is possible to imagine that the operator, in addition to the total value, specifies in the predefinition how many banknotes per denomination, whose total value should be less than the total amount of banknotes to be output again, are at least to be output at the same time.

For the proportion of the total value of the cash to be output again, for which the operator did not make any predefinitions with regard to the number of banknotes per denomination, the control computer 17 will output banknotes into the output compartment 5 in accordance with the result of the determination of denomination up to the predefined total amount, for example in accordance with a preset, possibly variable scheme.

Although in most cases during the cashing-up of a cash register the case will occur in which the operator wishes to receive fewer banknotes of a denomination output as change again than he himself put in during the current transaction for cashing-up a cash register, it could occur in infrequent cases that an insufficient number banknotes of one denomination is put in during the current transaction and can therefore be output again into the output compartment 5. In addition to the usual statement about the total value of the number banknotes per denomination which have been output again, it will in this case be displayed to the operator, for example, in addition a warning message on the operating unit 6 in order to draw his attention to the lacking banknotes.

Even when fewer notes of a denomination have been put in than can be paid out again during the current transaction, in order always to be able to output banknotes in the desired number, in addition to the cash handling apparatus, there may be a cash output apparatus, from which the operator can have paid out the lacking banknotes of the respective denomination which he wishes to have as change. In a known way, this cash output apparatus can, for example, comprise a film store or various storage containers, in which the banknotes are stacked in separate denominations.

If this additional cash output unit is integrated in the cash handling apparatus 1, it is usually likewise connected to the control computer 17, and will additionally output the lacking amounts of banknotes desired as change into the output compartment 5.

According to a further advantageous embodiment, the total value of the banknotes stored in the compartment 13 of the end cassette 15 during one transaction can not only be displayed and/or stored after being calculated by the control computer 17, but additionally or alternatively it is also possible for this total value to be transmitted to an accounting system, in order to credit the total value to an account, to a cash card or the like.

This means that, if the destination of the accounting in the control computer 17 has not yet been preset, the operator can specify, for example, to which account the amounts of the banknotes retained in the cassette 13 are to be credited.

According to a further embodiment, the data about the desired amount and/or the value of the banknotes to be output again during the current transaction are stored, in order to be used during the future transactions as predefined data about the banknotes to be output again.

If, for an operator or one or more cash registers to be cashed up, for example regularly the same amount of change is to be given back as change, the data can be stored, for example in the control computer 17 and, at the start of a subsequent transaction, following identification of the operator and/or the cash register currently to be cashed up, can be loaded as at least part of the predefined data.

If the operator wishes to use output data other than these predefined as standard, he can enter these via the operating unit 6. The changed data are then used as the predefinition for the current transaction. In addition, the data can also be used and stored in accordance with the predefinition of the operator as new predefined values for future transactions.

The present invention therefore makes it possible for transactions in which banknotes are both paid in and paid out again, for example as change, to be performed quickly and with the aid of a apparatus that is simply constructed.

1. Method in which, during one transaction, banknotes (8) are both paid into a cash handling apparatus (1) and are output again by the cash handling apparatus (1), which comprises the following steps:
input of banknotes (8) into an input device (3) of the cash handling apparatus (1);
deposition of banknotes (8) put in in a storage device (15) belonging to the cash handling apparatus (1);
predefinition of data about all or at least some of the banknotes (8) to be output again; and
output of banknotes (8) into an output device (5) belonging to the cash handling apparatus (1) as a function of the denomination of banknotes (8) and of the data entered about the banknotes to be output again;
characterized in that
the predefinition of data about the banknotes (8) to be output again is carried out before the banknotes (8) are drawn into the cash handling apparatus (1).

2. Method according to claim 1, characterized in that the predefinition of data is made by entering the data in a manual way and/or by remote data transmission, or the data of the predefinition are present in previously stored form.

3. Method according to claim 1 or 2, characterized in that the data specified about the banknotes (8) to be output again are the total value of banknotes (8) and/or the quantity of banknotes (8) per denomination and/or the type of denomination of banknotes which are at least to be output again.

4. Method according to one of the preceding claims, characterized in that all or at least some of the banknotes (8) output again are a subset of the banknotes (8) put in during the current transaction.

5. Method according to one of the preceding claims, characterized in the banknotes (8) put in during the current transaction are transported from the input device (3) to the output device (5), without intermediate stacking, in order to output banknotes (8) again in accordance with the predefined data.

6. Method according to one of the preceding claims, characterized in that of the banknotes (8) put in during the current transaction, banknotes (8) that are not recognised and/or cannot be processed further are transported to a first output compartment (4) of the output device (4, 5), serving as a reject compartment, and banknotes (8) that are recognised and/or can be processed further, following the registration of the denomination, are transported to a second output compartment (5) of the output device (4, 5) or to the storage device (15).

7. Method according to one of the preceding claims, characterized in that the total value of all or at least some of the banknotes (8) stored in the storage device (15) and/or the output device (5) during the current transaction is determined.

8. Method according to claim 7, characterized in that data about the total value of the stored banknotes (8) are transmitted to an accounting system, in order to credit the total value to an account, a cash card or the like.

9. Method according to one of the preceding claims, characterized in that the data about banknotes (8) to be output again during the current transaction are stored, in order to be used in future transactions as predefined data about the banknotes (8) to be output again.

10. Cash handling apparatus (1) with which, during one transaction, banknotes (8) can be paid in and banknotes (8) can be output again, the cash handling apparatus (1) comprising:
an input device (3) for the input of banknotes (8);
a storage device (15) for the storage of banknotes that are put in; and
predefining means (6) for the predefinition of data about all or at least some of the banknotes (8) to be output again; and
an output device (5) for the output of banknotes (8) as a function of the denomination of banknotes (8) and the data entered about the banknotes (8) to be output again;
characterized by
a control means (17) to perform the predefinition of the data about the banknotes (8) to be output again before the banknotes (8) are drawn into the cash handling apparatus (1).

11. Apparatus according to claim 10, characterized in that the redefining means comprises a means for the manual entry of the data and/or for the remote data transmission of the data and/or a means of storing the data previously.

12. Apparatus according to claim 10 or 11, characterized in that the data about the banknotes (8) to be output again comprise the total value of banknotes (8) and/or the quantity of banknotes (8) per denomination and/or the type of denomination of banknotes (8) which are at least to be output again.

13. Apparatus according to one of claims 10 to 12, characterized in that the apparatus is configured in such a way that all or at least some of the banknotes (8) output again are a subset of the banknotes (8) put in during the current transaction.

14. Apparatus according to one of claims 10 to 13, characterized by a transport device (9) to transport banknotes (8) put in during the current transaction from the input device (3) to the output device (5) without intermediate stacking.

15. Apparatus according to one of claims 10 to 14, characterized by a checking device (10) for checking the banknotes put in during the current transaction in accordance with predefined criteria, in order to determine the denomination, the authenticity, the suitability for circulation or the like of the banknotes checked.

16. Apparatus according to claim 15, characterized by a transport device (9), to transport banknotes (8) not accepted by the checking device (10), such as banknotes that are not recognised and/or cannot be processed further, to a first output compartment (4) of the output device (4, 5), serving as a reject compartment, and to transport banknotes (8) that are accepted by the checking device (10), such as banknotes that are recognised and/or can be processed further, following the registration of their denomination, to a second output compartment (5) of the output device (4, 5) or to the storage device (15).

17. Apparatus according to one of claims 10 to 16, characterized by a means (17) of determining the total value of all or at least some of the banknotes (8) stored in the storage device (15) and/or the output device (5) during the current transaction.

18. Apparatus according to claim 17, characterized by a means to transmit the total value of the stored banknotes (8) to an accounting system, in order to credit the total value to an account, a cash card or the like.

19. Apparatus according to one of claims 10 to 18, characterized by a data store (17) to store data about the banknotes (8) to be output again during the current transaction, in order to use the data during future transactions as predefined data about the banknotes (8) to be output again.
